(19) United States
(12) Patent Application Publication
(10) Pub. No.: US 2007/0014927 A1
(43) Pub. Date: Jan. 18, 2007

(54) Fluorochemical urethane composition for treatment of fibrous substrates

(76) Inventors: Richard S. Buckanin, Woodbury, MN (US); Cheryl L. S. Elsbernd, Woodbury, MN (US); Richard M. Flynn, Mahtomedi, MN (US); Jung-Sheng Wu, Woodbury, MN (US)

Correspondence Address: 3M INNOVATIVE PROPERTIES COMPANY, PO BOX 33427, ST. PAUL, MN, 55133-3427, US

(21) Appl. No.: 11/183,004

(22) Filed: Jul. 15, 2005

(51) Int. Cl. B05D 3/02

(52) U.S. Cl. 427/372.2

(57) ABSTRACT

Fluorochemical urethane composition comprising one or more fluorochemical urethane compounds, and one or more auxiliary hydrophobic compounds for treatment of a fibrous substrate to impart or improve one or more of the oil-repellency, stain- and/or soil repellency and stain and/or soil release properties, with improved durability, of the fibrous substrate treated with the composition. Also articles made with such compositions and methods of applying such compositions.

### FIELD OF THE INVENTION

This invention relates to chemical compositions comprising one or more fluorochemical urethane compounds, and one or more auxiliary compounds for treatment of a fibrous substrate. The invention further relates to fluorochemical coating compositions comprising at least one solvent and the chemical compositions of the present invention. The coating compositions are capable of improving one or more of the oil-repellency, stain- and/or soil repellency and stain and/or soil release properties, with improved durability, of the fibrous substrate treated with the composition. This invention also relates to articles comprising a fibrous substrate bearing a cured coating derived from the coating compositions of the present invention. The cured coating resists being worn-off due to wear, abrasion and cleaning. In another aspect, this invention relates to a process for imparting stain-release characteristics to substrates.

### BACKGROUND OF THE INVENTION

The use of certain fluorochemical compositions on fibers and fibrous substrates, such as textiles, paper, and leather, to impart oil- and water-repellency and soil- and stain-resistance is well known in the art. See, for example, Banks, Ed., Organofluorine Chemicals and Their Industrial Applications, Ellis Horwood Ltd., Chichester, England, 1979, pp. 226-234. Fluorochemical compositions that have been disclosed include, for example, fluorochemical guanidines (U.S. Pat. No. 4,540,497, Chang et al.), compositions of cationic and non-cationic fluorochemicals (U.S. Pat. No. 4,566,981, Howells), compositions containing fluorochemical carboxylic acid and epoxidic cationic resin (U.S. Pat. No. 4,426,466, Schwartz), fluoroaliphatic carbodiimides (U.S. Pat. No. 4,215,205, Landucci), fluoroaliphatic alcohols (U.S. Pat. No. 4,468,527, Patel), fluorine-containing addition polymers, copolymers, and macromers (U.S. Pat. Nos. 2,803,615; 3,068,187; 3,102,103; 3,341,497; 3,574,791; 3,916,053; 4,529,658; 5,216,097; 5,276,175; 5,725,789; 6,037,429), fluorine-containing phosphate esters (U.S. Pat. Nos. 3,094,547; 5,414,102; 5,424,474), fluorine-containing urethanes (U.S. Pat. Nos. 3,987,182; 3,987,227; 4,504,401; 4,958,039; 6,890,360), fluorochemical allophanates (U.S. Pat. No. 4,606,737), fluorochemical biurets (U.S. Pat. No. 4,668,406), fluorochemical oxazolidinones (U.S. Pat. No. 5,025,052), and fluorochemical piperazines (U.S. Pat. No. 5,451,622).

The need exists for fluorochemical compositions that provide improved uniform durable properties.

### SUMMARY OF THE INVENTION

The present invention provides novel fluorochemical compositions that can impart one or more of the following uniform, durable properties: oil-repellency and/or soil- and stain-resistance and/or soil- and stain-repellency. These fluorochemical compositions may be water and/or organic solvent soluble.

In one aspect, this invention relates to chemical compositions comprising one or more fluorochemical urethane compounds, and one or more auxiliary compounds capable of further improving the soil- and/or stain release and oil-repellency of a fibrous substrate. These urethane compounds comprise the reaction product of: (a) one or more polyfunctional isocyanate compounds; (b) one or more hydrophilic polyoxyalkylene compounds; (c) one or more fluorochemical monofunctional compounds and may further optionally comprise (d) one or more isocyanate-reactive silanes; and/or (e) a moiety having an isocyanate blocking group such as methyl ethyl ketone oxime, etc. The chemical compositions of the present invention, comprising one or more urethane compounds, impart one or more of release, repellency and resistance characteristics to oil, stains and soils, and exhibit durability (i.e., they resist being worn-off) when exposed to wear and abrasion from use, cleaning, and the elements. Therefore, these compositions can be applied as coatings to a wide variety of substrates, for example, by topical application, to impart durable release/repellency/resistant properties to the substrates. When applied as a coating, the chemical compositions of the present invention can provide uniform properties to a fibrous substrate and do not change the appearance of the substrate to which they are applied. Even though the urethane compounds are of relatively low fluorochemical content, the chemical compositions of the present invention provide durable stain-release properties comparable to or better than those of the prior art Certain preferred embodiments of the chemical compositions of the present invention include those compositions comprising terminal fluorochemical groups having from two to twelve carbons, preferably from three to six carbons, and more preferably four carbons. Even with R_{f} groups that are relatively short (i.e., six or fewer carbons), these chemical compositions, surprisingly, exhibit excellent release/resistance/repellency. Although compositions comprising lower fluorine content are less expensive, those of skill in the art have typically overlooked R_{f} groups shorter than eight carbons because they have been known to impart inferior oil- and water-repellency and stain resistance.

Another embodiment of the present invention relates to a composition for treatment of fibrous substrates comprising a mixture of the chemical composition of the present invention and a solvent. In this embodiment, it is important that the chemical composition be dissolved or dispersed in the solvent. When applied to a substrate, this treatment composition provides a uniform distribution of the chemical composition on the substrate without altering the appearance of the substrate. With some embodiments a high temperature cure is not required to provide this coating; the treatment composition can be cured (i.e., dried) at ambient temperatures. In other embodiments a high temperature cure (e.g., temperatures in above about 125° F. or 49° C.) may be used with coating compositions of the invention.

This invention also relates to an article comprising a fibrous substrate having a cured coating derived from at least one solvent and a chemical composition of the present invention. After application and curing of the chemical composition, the substrate displays durable release/resistance/repellency properties.

This invention further relates to a method for imparting stain-release characteristics to a fibrous substrate, having one or more surfaces, comprising the steps of: (a) applying the coating composition of the present invention onto one or more surfaces of the substrate and (b) allowing the coating composition to cure (i.e., dry).

Definitions

Unless otherwise stated, the following terms used in the specification and claims have the meanings given below:

“Acyloxy” means a radical —OC(O)R where R is, alkyl, alkenyl, and cycloalkyl, e.g., acetoxy, 3,3,3-trifluoroacetoxy, propionyloxy, and the like.

“Alkoxy” means a radical —OR where R is an alkyl group as defined below, e.g., methoxy, ethoxy, propoxy, butoxy, and the like.

“Alkyl” means a linear saturated monovalent hydrocarbon radical having from one to about twelve carbon atoms or a branched saturated monovalent hydrocarbon radical having from three to about twelve carbon atoms, e.g., methyl, ethyl, 1-propyl, 2-propyl, pentyl, and the like.

“Alkylene” means a linear saturated divalent hydrocarbon radical having from one to about twelve carbon atoms or a branched saturated divalent hydrocarbon radical having from three to about twelve carbon atoms, e.g., methylene, ethylene, propylene, 2-methylpropylene, pentylene, hexylene, and the like.

“Aryl aliphatic” means an alkylene radical defined above with an aromatic group attached to the alkylene radical, e.g., benzyl, pyridylmethyl, 1-naphthylethyl, and the like.

“Cured chemical composition” means that the chemical composition is dried or solvent has evaporated from the chemical composition at ambient temperature (15 to 35° C.) for up to approximately 24 hours or at elevated temperature until dryness.

“Fibrous substrate” means materials comprised of synthetic fibers such as wovens, knits, nonwovens, carpets, and other textiles; and materials comprised of natural fibers such as cotton, paper, and leather.

“Fluorocarbon monofunctional compound” means a compound having one isocyanate-reactive functional group and a perfluoroalkyl or a perfluoroheteoralkyl group, e.g., C₄F₉SO₂N(CH₃)CH₂CH₂OH, C₄F₉SO₂N(CH₃)CH₂CH₂NH₂, C₄F₉CH₂CH₂OH, C₄F₉CH₂CH₂SH, C₂F₅O(C₂F₄O)₃CF₂CONHC₂H₄OH, C₂F₅O(C₂F₄O)₃CF₂CONHC₂H₄CO₂H, C₆F₁₃CH₂OH, C₆ μl₃CH₂N(CH₃)CH₂CH₂OH, C₃F₇O[CF(CF₃)CF₂O]ₚCF(CF₃)CON(H)CH₂CH₂OH, where p is greater than or equal to 3 and the like.

“Fluorochemical urethane compound” means a compound derived or derivable from the reaction of at least one polyfunctional isocyanate compound at least one hydrophilic polyoxyalkylene compound, and at least one fluorinated monofunctional compound

“Heteroacyloxy” has essentially the meaning given above for acyloxy except that one or more heteroatoms (i.e. oxygen, sulfur, and/or nitrogen) may be present in the R group and the total number of carbon atoms present may be up to 50, e.g., CH₃CH₂OCH₂CH₂C(O)O—, C₄H₉OCH₂CH₂OCH₂CH₂C(O)O—, CH₃O(CH₂CH₂O)ᵣCH₂CH₂C(O)O—, and the like.

“Heteroalkoxy” has essentially the meaning given above for alkoxy except that one or more heteroatoms (i.e. oxygen, sulfur, and/or nitrogen) may be present in the alkyl chain and the total number of carbon atoms present may be up to 50, e.g., CH₃CH₂OCH₂CH₂O—, C₄H₉OCH₂CH₂OCH₂CH₂O—, CH₃O(CH₂CH₂O)ᵣH, and the like.

“Heteroalkyl” has essentially the meaning given above for alkyl except that one or more catenated (that is—in chain) heteroatoms (i.e., oxygen, sulfur, and/or nitrogen) may be present in the alkyl chain, these heteroatoms being separated from each other by at least one carbon, e.g., CH₃CH₂OCH₂CH₂—, CH₃CH₂OCH₂CH₂OCH(CH₃)CH₂—, C₄F₉CH₂CH₂SCH₂CH₂—, and the like.

“Heteroalkylene” has essentially the meaning given above for alkylene except that one or more catenated heteroatoms (i.e., oxygen, sulfur, and/or nitrogen) may be present in the alkylene chain, these heteroatoms being separated from each other by at least one carbon, e.g., —CH₂OCH₂O—, —CH₂CH₂OCH₂CH₂—, —CH₂CH₂N(CH₃)CH₂CH₂—, —CH₂CH₂SCH₂CH₂—, and the like.

“Heteroaryl aliphatic” means an aryl aliphatic radical defined above except that catenated oxygen, sulfur, and/or nitrogen atoms may be present, e.g., phenyleneoxymethyl, phenyleneoxyethyl, benzyleneoxymethyl, and the like.

“Halo” means fluoro, chloro, bromo, or iodo, preferably fluoro and chloro.

“Isocyanate blocking group” means a group capable of reacting with an isocyanate group providing abeyant reactivity. As used herein, abeyant chemical reactivity means the reactive character is existing in a temporarily inactive form or state, i.e., the reactivity is temporarily set aside and is capable is being regenerated at some future time.

“Isocyanate-reactive functional group” means a functional group that is capable of reacting with an isocyanate group, such as hydroxyl, amino, thiol, etc.

“Perfluoroalkyl” has essentially the meaning given above for “alkyl” except that all or essentially all of the hydrogen atoms of the alkyl radical are replaced by fluorine atoms and the number of carbon atoms is from 2 to about 12, e.g., perfluoropropyl, perfluorobutyl, perfluorooctyl, and the like.

“Perfluoroalkylene” has essentially the meaning given above for “alkylene” except that all or essentially all of the hydrogen atoms of the alkylene radical are replaced by fluorine atoms, e.g., perfluoropropylene, perfluorobutylene, perfluorooctylene, and the like.

“Perfluoroheteroalkyl” has essentially the meaning given above for “heteroalkyl” except that all or essentially all of the hydrogen atoms of the heteroalkyl radical are replaced by fluorine atoms and the number of carbon atoms is from 3 to about 100, e.g. CF₃CF₂OCF₂CF₂—, CF₃CF₂O(CF₂CF₂O)₃CF₂CF₂—, C₃F₇O(CF(CF₃)CF₂O)ₚCF(CF₃)— where p is greater than or equal to 3.

“Perfluoroheteroalkylene” has essentially the meaning given above for “heteroalkylene” except that all or essentially all of the hydrogen atoms of the heteroalkylene radical are replaced by fluorine atoms, and the number of carbon atoms is from 3 to about 100, e.g., —CF₂OCF₂—, —CF₂O(CF₂O)ₙ(CF₂CF₂O)ₘCF₂—, C₃F₇O(CF(CF₃)CF₂O)ₚCF(CF₃)— and the like wherein n and m are the same or different and p is equal to or greater than 3.

“Perfluorinated group” means an organic group wherein all or essentially all of the carbon bonded hydrogen atoms are replaced with fluorine atoms, e.g., perfluoroalkyl, perfluoroheteroalkyl, and the like.

“Polyisocyanate compound” means a compound containing two or more isocyanate radicals, —NCO, attached to a multivalent organic group, e.g. hexamethylene diisocyanate, the biuret and isocyanurate of hexamethylene diisocyanate, and the like.

“Reactive polyoxyalkylene” means a polymer having oxyalkylene repeat units with an average of 1 or more isocyanate-reactive functional groups per molecule.

“Silane group” means a group comprising silicon to which at least one hydrolyzable group is bonded, e.g., —Si(OCH₃)₃, —Si(OOCCH₃)₂CH₃, —Si(Cl)₃, and the like.

“Repellency” is a measure of a treated substrate's resistance to wetting by oil and/or water and or adhesion of particulate soil. Repellency may be measured by the test methods described herein.

“Resistance” is the context or soiling or staining is a measure of the treated substrate's ability to avoid staining and/or soiling when contacted by stain or soil respectively.

“Release” is a measure of the treated substrate's ability to have soil and/or stain removed by cleaning or laundering.

“Release/resistance/repellency” means the composition demonstrates at least one of oil repellency, water repellency, stain release, stain repellency, soil release and soil repellency.

### DETAILED DESCRIPTION OF THE ILLUSTRATIVE EMBODIMENTS OF THE INVENTION

The chemical compositions of the present invention comprise one or more fluorochemical urethane compounds and one or more hydrophobic auxiliary agents capable of further improving the resistance/release/repellency of a fibrous substrate treated with the fluorochemical urethane compounds. It has been surprisingly found that the oil resistance imparted by coating compositions comprising fluorochemical urethane compounds as described herein can be improved by incorporating, i.e., blending, into the composition certain hydrophobic hydrocarbon auxiliary agents as discussed herein.

Fluorochemical Urethane

The fluorochemical urethane compound(s) used in compositions of the invention comprise the reaction product of (a) one or more polyfunctional isocyanate compounds; (b) one or more hydrophilic polyoxyalkylene compounds; and (c) one or more fluorochemical monofunctional compounds; and (d) optionally, one or more silane compounds; and/or (e) optionally, an isocyanate blocking group such a oxime, etc.

The fluorochemical urethane compounds can be described as:
Q(NHCO)ₓ(X′R²ZR_{f})ₐ(X′R³X′)_{b}(X′R⁴)_{c}(X′R¹Si(Y₃))_{d}(X′W)ₑ
Wherein:

x is an integer from 2 to 20,

a is from 1 to x,

b is from 1 to 0.3 x,

c is from 0 to 0.3 x,

d is from 0 to 0.25 x,

e is from 0 to 0.6 x

with the proviso that b+c is at least 0.0005 x, and Q, X′, R², Z, R_{f}, R³, R⁴, R¹, Y, and W are as defined below.

Each fluorochemical urethane compound comprises a urethane group that is derived or derivable from the reaction of at least one polyfunctional isocyanate compound and at least one hydrophilic polyoxyalkylene compound. The fluorochemical urethane compound is terminated, on average, with (i) one or more perfluoroalkyl groups, one or more perfluoroheteroalkyl groups; and (ii) optionally, one or more silane groups; and/or (iii) optionally, one or more isocyanate blocking groups. It will be understood that the reaction product will provide a mixture of compounds, some percentage of which will comprise compounds as described, but may further comprise urethane compounds having different substitution patterns and degree of substitution.

In one preferred embodiment, the composition of the present invention comprises 1) a mixture of urethane molecules arising from the reaction of (a) one or more polyfunctional isocyanate compounds, (b) one or more hydrophilic polyoxyalkylene compounds, (c) one or more fluorochemical monofunctional compounds, and (d) optionally, one or more silane compounds, and/or (e) optionally one or more isocyanate blocking groups and 2) one or more auxiliary compounds as described below.

Generally, the amount of said hydrophilic polyoxyalkylene compound is sufficient to react with between about 0.05 and 30 percent of available isocyanate groups, the amount of said silanes when used is sufficient to react with between about 0.1 and 25 percent of available isocyanate groups, the amount of said isocyanate blocking group when used is sufficient to react with between about 0.1 and 60 percent of available isocyanate groups and the amount of said fluorochemical monofunctional compounds is sufficient to react with between about 40 and 90 percent of available isocyanate groups. Preferably, the amount of said hydrophilic polyoxyalkylene(s) is sufficient to react with between about 3 and 30 percent of available isocyanate groups, the amount of said silanes is sufficient to react with between 0.1 and 15 percent of available isocyanate groups, the amount of said isocyanate blocking group when used is sufficient to react with between 10 and 50 percent of available isocyanate groups and the amount of said fluorochemical monofunctional compounds is sufficient to react with between 50 and 90 percent of available isocyanate groups.

Some preferred classes of urethane compounds that may be present are represented by the following formulas:
R_{f}ZR²—X′(—CONH-Q(A)ₘ—NHCO—X′R⁴—)ₙ (I)
R⁴X′(—CONH-Q(A)ₘ—NHCOX′R²ZR_{f})ₙ (II)
(R_{f}ZR²—X′)ₗ(—CONH-Q(A)ₘ—NHCO—X′R³X′—)ₙCONH-Q(A)—NHCO—X′R′Si(Y)₃ (III)
(R_{f}ZR²—X′)ₗ(—CONH-Q(A)ₘ—NHCO—X′R³X′—)ₙCONHR¹Si(Y)₃ (IV)
(R_{f}ZR²—X′)ₗ(—CONH-Q(A)ₘ—NHCO—X′R³X′—)ₙCONH-Q(A)-NHCO—W (V)
wherein:

R_{f}ZR²— is a residue of at least one of the fluorochemical monofunctional compounds;

R_{f} is a perfluoroalkyl group having 2 to about 12 carbon atoms, or a perfluoroheteroalkyl group having 3 to about 50 carbon atoms;

Z is a covalent bond, sulfonamido (—SO₂NR—), or carboxamido (—CONR—) where R is hydrogen or alkyl, a carboxyl group, or a sulfonyl group;

R¹ is an alkylene, heteroalkylene, aryl alkylene, or heteroaryl aliphatic group;

R² is a divalent straight or branched chain alkylene, cycloalkylene, or heteroalkylene group of 1 to 14 carbon atoms, preferably 1 to 8 carbon atoms, more preferably 1 to 4 carbon atoms, and most preferably two carbon atoms, and preferably R² is alkylene or heteroalkylene of 1 to 14 carbon atoms;

Q is a multi-valent organic group that is a residue of the polyfunctional isocyanate compound;

R³ is a polyvalent, preferably divalent, organic group which is a residue of the hydrophilic polyoxyalkylene;

R⁴ is monovalent organic group which is a residue of the hydrophilic polyoxyalkylene;

X′ is —O—, —S—, or —N(R)—, wherein R is hydrogen or C₁-C₄ alkyl;

each Y is independently a hydroxy; a hydrolyzable moiety selected from the group consisting of alkoxy, acyloxy, heteroalkoxy, heteroacyloxy, halo, and oxime; or a non-hydrolyzable moiety selected from the group consisting of phenyl, alicyclic, straight-chain aliphatic, and branched-chain aliphatic, wherein at least one Y is a hydrolyzable moiety.

W is the residue of a moiety capable of reacting with an isocyanate group and possesses abeyant chemical reactivity such as oxime, lactam, phenol, and the like.

A is selected from the group consisting of R_{f}ZR²—OCONH—, (Y)₃SiR¹XCONH—, and (Y)₃SiR¹NHCOOR³OCONH—.

l is an integer from 1 to (m+n−1).

m is an integer from 0 to 2; and

n is an integer from 1 to 10.

It will be understood with respect to the above formulas that the compounds represent theoretical structures for the reaction products. The reaction product will contain a mixture of compounds in which the substitution patterns of the isocyanate groups will vary.

Polyfunctional isocyanate compounds useful in the present invention comprise isocyanate groups attached to the multivalent organic group, Q, which can comprise a multivalent aliphatic, alicyclic, or aromatic moiety; or a multivalent aliphatic, alicyclic or aromatic moiety attached to a blocked isocyanate, a biuret, an isocyanurate, or a uretdione, or mixtures thereof. Preferred polyfunctional isocyanate compounds contain at least two and preferably three or more —NCO groups. Compounds containing two —NCO groups are comprised of divalent aliphatic, alicyclic, arylaliphatic, or aromatic moieties to which the —NCO radicals are attached. Preferred compounds containing three —NCO radicals are comprised of isocyanatoaliphatic, isocyanatoalicyclic, or isocyanatoaromatic, monovalent moieties, which are attached to a biuret or an isocyanurate.

Representative examples of suitable polyfunctional isocyanate compounds include isocyanate functional derivatives of the polyfunctional isocyanate compounds as defined herein. Examples of derivatives include, but are not limited to, those selected from the group consisting of ureas, biurets, allophanates, dimers and trimers (such as uretdiones and isocyanurates) of isocyanate compounds, and mixtures thereof. Any suitable organic polyisocyanate, such as an aliphatic, alicyclic, aryl aliphatic, or aromatic polyisocyanate, may be used either singly or in mixtures of two or more.

The aliphatic polyfunctional isocyanate compounds generally provide better light stability than the aromatic compounds, and are preferred for treatment of fibrous substrates. Aromatic polyfunctional isocyanate compounds, on the other hand, are generally more economical and reactive toward hydrophilic polyoxyalkylene compounds and other isocyanate-reactive compounds than are aliphatic polyfunctional isocyanate compounds.

Suitable aromatic polyfunctional isocyanate compounds include, but are not limited to, those selected from the group consisting of 2,4-toluene diisocyanate (TDI), 2,6-toluene diisocyanate, an adduct of TDI with trimethylolpropane (available as Desmodur™ CB from Bayer Corporation, Pittsburgh, Pa.), the isocyanurate trimer of TDI (available as Desmodur™ IL from Bayer Corporation, Pittsburgh, Pa.), diphenylmethane 4,4′-diisocyanate (MDI), diphenylmethane 2,4′-diisocyanate, 1,5-diisocyanato-naphthalene, 1,4-phenylene diisocyanate, 1,3-phenylene diisocyanate, 1-methyloxy-2,4-phenylene diisocyanate, 1-chlorophenyl-2,4-diisocyanate, and mixtures thereof.

Examples of useful alicyclic polyfunctional isocyanate compounds include, but are not limited to, those selected from the group consisting of dicyclohexylmethane diisocyanate (H₁₂MDI, commercially available as Desmodur™ W, available from Bayer Corporation, Pittsburgh, Pa.), 4,4′-isopropyl-bis(cyclohexylisocyanate), isophorone diisocyanate (IPDI), cyclobutane-1,3-diisocyanate, cyclohexane 1,3-diisocyanate, cyclohexane 1,4-diisocyanate (CHDI), 1,4-cyclohexanebis(methylene isocyanate) (BDI), 1,3-bis(isocyanatomethyl)cyclohexane (H₆XDI), 3-isocyanatomethyl-3,5,5-trimethylcyclohexyl isocyanate, and mixtures thereof.

Examples of useful aliphatic polyfunctional isocyanate compounds include, but are not limited to, those selected from the group consisting of 1,4-tetramethylene diisocyanate, hexamethylene 1,4-diisocyanate, hexamethylene 1,6-diisocyanate (HDI), 1,12-dodecane diisocyanate, 2,2,4-trimethyl-hexamethylene diisocyanate (TMDI), 2,4,4-trimethyl-hexamethylene diisocyanate (TMDI), 2-methyl-1,5-pentamethylene diisocyanate, dimer diisocyanate, the urea of hexamethylene diisocyanate, the biuret of hexamethylene 1,6-diisocyanate (HDI) (available as Desmodur™ N-100 and N-3200 from Bayer Corporation, Pittsburgh, Pa.), the isocyanurate of HDI (available as Demodur™ N-3300 and Desmodur™ N-3600 from Bayer Corporation, Pittsburgh, Pa.), a blend of the isocyanurate of HDI and the uretdione of HDI (available as Desmodur™ N-3400 available from Bayer Corporation, Pittsburgh, Pa.), and mixtures thereof.

Examples of useful aryl aliphatic polyisocyanates include, but are not limited to, those selected from the group consisting of m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, p-(1-isocyanatoethyl)-phenyl isocyanate, m-(3-isocyanatobutyl)-phenyl isocyanate, 4-(2-isocyanatocyclohexyl-methyl)-phenyl isocyanate, and mixtures thereof.

Preferred polyisocyanates, in general, include those selected from the group consisting of hexamethylene 1,6-diisocyanate (HDI), 1,12-dodecane diisocyanate isophorone diisocyanate, toluene diisocyanate, dicyclohexylmethane 4,4′-diisocyanate, MDI, derivatives of all the aforementioned, including Desmodur™ N-100, N-3200, N-3300, N-3400, N-3600, and mixtures thereof.

Suitable commercially available polyfunctional isocyanates are exemplified by Desmodur™ N-3200, Desmodur™ N-3300, Desmodur™ N-3400, Desmodur™ N-3600, Desmodur™ H (HDI), Desmodur™ W (bis[4-isocyanatocyclohexyl]methane), Mondur™ M (4,4′-diisocyanatodiphenylmethane), Mondur™ TDS (98% toluene 2,4-diisocyanate), Mondur™ TD-80 (a mixture of 80% 2,4 and 20% 2,6-toluene diisocyanate isomers), and Desmodur™ N-100, each available from Bayer Corporation, Pittsburgh, Pa.

Other useful triisocyanates are those obtained by reacting three moles of a diisocyanate with one mole of a triol. For example, toluene diisocyanate, 3-isocyanatomethyl-3,4,4-trimethylcyclohexyl isocyanate, or m-tetramethylxylene diisocyanate can be reacted with 1,1,1-tris(hydroxymethyl)propane to form triisocyanates. The product from the reaction with m-tetramethylxylene diisocyanate is commercially available as CYTHANE 3160 (American Cyanamid, Stamford, Conn.).

Hydrophilic polyoxyalkylene compounds suitable for use in preparing the first component fluorochemical urethane compounds of the present invention include those polyoxyalkylene compounds that have an average functionality of 1 or greater (preferably, about 1 to 5; more preferably, about 1 to 3; most preferably, about 1 to 2). The isocyanate-reactive groups can be primary or secondary, with primary groups being preferred for their greater reactivity. Mixtures of compounds having different functionalities, for examples mixtures of polyoxyalkylene compounds having one, two and three isocyanate-reactive groups, may be used provided the average is equal to or greater than 1. The polyoxyalkylene groups include those having 1 to 3 carbon atoms such as polyoxyethylene, polyoxypropylene, and copolymers thereof such as polymers having both oxyethylene and oxypropylene units.

Examples of polyoxyalkylene containing compounds include alkyl ethers of polyglycols such as, e.g., methyl or ethyl ether of polyethylene glycol, hydroxy terminated methyl or ethyl ether of a random or block copolymer of ethylene oxide and propylene oxide, amino terminated methyl or ethyl ether of polyethylene oxide, polyethylene glycol, polypropylene glycol, a hydroxy terminated copolymer (including a block copolymer) of ethylene oxide and propylene oxide, a mono- or diamino-terminated poly(alkylene oxide) such as Jeffamine™ ED, Jeffamine™ EDR-148 and poly(oxyalkylene)thiols. Commercially available aliphatic polyisocyanates include Baygard™ VP SP 23012, Rucoguard™ EPF 1421 and Tubicoat™ Fix ICB.

Useful commercially available hydrophilic polyoxyalkylene compounds for the first component include Carbowax™ poly(ethylene glycol) materials in the number average molecular weight (Mₙ) range of from about 200 to about 2000 (available from Union Carbide Corp.); poly(propylene glycol) materials such as PPG-425 (available from Lyondell Chemicals); block copolymers of poly(ethylene glycol) and poly(propylene glycol) such as Pluronic™ L31 (available from BASF Corporation); the “PeP” series (available from Wyandotte Chemicals Corporation) of polyoxyalkylene tetrols having secondary hydroxyl groups, for example, “PeP” 450, 550, and 650.

Fluorochemical monofunctional compounds suitable for use in preparing the chemical compositions of the present invention include those that comprise at least one R_{f} group. The R_{f} groups can contain straight chain, branched chain, or cyclic fluorinated alkylene groups or any combination thereof. The R_{f} groups can optionally contain one or more heteroatoms (i.e., oxygen, sulfur, and/or nitrogen) in the carbon-carbon chain so as to form a carbon-heteroatom-carbon chain (i.e., a heteroalkylene group). Fully-fluorinated groups are generally preferred, but hydrogen or chlorine atoms can also be present as substituents, provided that no more than one atom of either is present for every two carbon atoms. It is additionally preferred that any R_{f} group contain at least about 40% fluorine by weight, more preferably at least about 50% fluorine by weight. The terminal portion of the group is generally fully-fluorinated, preferably containing at least three fluorine atoms, e.g., CF₃O—, CF₃CF₂—, CF₃CF₂CF₂—, (CF₃)₂N—, (CF₃)₂CF—, SF₅CF₂—. Perfluorinated aliphatic groups (i.e., those of the formula CₙF₂ₙ₊₁—) wherein n is 2 to 12 inclusive are the preferred R_{f} groups, with n=3 to 5 being more preferred and with n=4 being the most preferred.

Useful fluorochemical monofunctional compounds include compounds of the following formula:
R_{f}-Z-R²—X
wherein:

R_{f}, Z, and R² are each as defined above; and

X is an isocyanate-reactive functional groups, for example —NH₂; —SH; —OH; —COOH; or —NRH where R is H or a C₁ to C₄ alkyl.

Representative examples of useful fluorochemical monofunctional compounds include the following:

| | |
|---|---|
| CF₃(CF₂)₃SO₂N(CH₃)CH₂CH₂OH, | CF₃(CF₂)₃SO₂N(CH₃)CH(CH₃)CH₂OH, |
| CF₃(CF₂)₃SO₂N(CH₃)CH₂CH(CH₃)NH₂, | CF₃(CF₂)₃SO₂N(CH₂CH₃)CH₂CH₂SH, |
| CF₃(CF₂)₃SO₂N(CH₃)CH₂CH₂SCH₂CH₂OH, | C₆F₁₃SO₂N(CH₃)(CH₂)₄OH, |
| CF₃(CF₂)₇SO₂N(H)(CH₂)₃OH, | C₃F₇SO₂N(CH₃)CH₂CH₂OH, |
| CF₃(CF₂)₄SO₂N(CH₃)(CH₂)₄NH₂, | C₄F₉SO₂N(CH₃)(CH₂)₁₁OH, |
| CF₃(CF₂)₅SO₂N(CH₂CH₃)CH₂CH₂OH, | CF₃(CF₂)₅SO₂N(C₂H₅)(CH₂)₆OH, |
| CF₃(CF₂)₂SO₂N(C₂H₅)(CH₂)₄OH, | CF₃(CF₂)₃SO₂N(C₃H₇)CH₂OCH₂CH₂CH₂OH, |
| CF₃(CF₂)₄SO₂N(CH₂CH₂CH₃)CH₂CH₂OH, | CF₃(CF₂)₄SO₂N(CH₂CH₂CH₃)CH₂CH₂NHCH₃, |
| CF₃(CF₂)₃SO₂N(C₄H₉)CH₂CH₂NH₂, | CF₃(CF₂)₃SO₂N(C₄H₉)(CH₂)₄SH, |
| CF₃(CF₂)₃CH₂CH₂OH | C₄F₉OC₂F₄OCF₂CH₂OCH₂CH₂OH; |
| n-C₆F₁₃CF(CF₃)CON(H)CH₂CH₂OH; | C₆F₁₃CF(CF₃)CO₂C₂H₄CH(CH₃)OH; |
| C₃F₇CON(H)CH₂CH₂OH; | C₃F₇O(CF(CF₃)CF₂O)₁₋₃₆CF(CF₃)CH₂OH; |
| 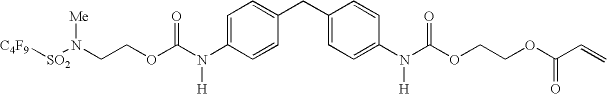 | C₃F₇O(CF(CF₃)CF₂O)₁₋₃₆CF (CF₃)CON(H)CH₂CH₂OH |

and the like, and mixtures thereof. If desired, other isocyanate-reactive functional groups may be used in place of those depicted.

Silane compounds suitable for use in the chemical compositions of the present invention are those of the following formula:
X—R¹—Si—(Y)₃
wherein X, R¹, and Y are as defined previously. Therefore, these silane compounds contain one, two, or three hydrolysable groups (Y) on the silicon and one organic group including an isocyanate-reactive or an active hydrogen reactive radical (X—R¹). Any of the conventional hydrolysable groups, such as those selected from the group consisting of alkoxy, acyloxy, heteroalkoxy, heteroacyloxy, halo, oxime, and the like, can be used as the hydrolyzable group (Y). The hydrolysable group (Y) is preferably alkoxy or acyloxy and more preferably alkoxy.

When Y is halo, the hydrogen halide liberated from the halogen-containing silane can cause polymer degradation when cellulose substrates are used. When Y is an oxime group, lower oxime groups of the formula —ON═CR⁵R⁶, wherein R⁵ and R⁶ are monovalent lower alkyl groups comprising about 1 to about 12 carbon atoms, which can be the same or different, preferably selected from the group consisting of methyl, ethyl, propyl, and butyl, are preferred.

Representative divalent bridging radicals (R¹) include, but are not limited to, those selected from the group consisting of —CH₂CH₂—, —CH₂CH₂CH₂—, —CH₂CH₂CH₂OCH₂CH₂—, —CH₂CH₂C₆H₄CH₂CH₂—, and —CH₂CH₂O(C₂H₄₀)₂CH₂CH₂N(CH₃)CH₂CH₂CH₂—.

Other preferred silane compounds are those which contain one or two hydrolyzable groups, such as those having the structures R²OSi(R⁷)₂R¹XH and (R⁸O)₂Si(R⁷)R¹XH, wherein R¹ is as previously defined, and R⁷ and R⁸ are selected from the group consisting of a phenyl group, an alicycylic group, or a straight or branched aliphatic group having from about 1 to about 12 carbon atoms. Preferably, R⁷ and R⁸ are a lower alkyl group comprising 1 to 4 carbon atoms.

Following the hydrolysis of some of these terminal silane groups, reaction with a substrate surface comprising —SiOH groups or other metal hydroxide groups to form siloxane or metal-oxane linkages, e.g., 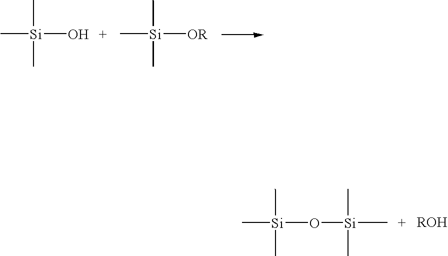
can occur. Bonds thus formed, particularly Si—O—Si bonds, are water resistant and can provide enhanced durability of the stain-release properties imparted by the chemical compositions of the present invention.

Such silane compounds are well known in the art and many are commercially available or are readily prepared. Representative isocyanate-reactive silane compounds include, but are not limited to, those selected from the group consisting of:

| | |
|---|---|
| H₂NCH₂CH₂CH₂Si(OC₂H₅)₃; | H₂NCH₂CH₂CH₂Si(OCH₃)₃; |
| H₂NCH₂CH₂CH₂Si(O—N═C(CH₃)(C₂H₅))₃ | HSCH₂CH₂CH₂Si(OCH₃)₃; |
| HO(C₂H₄O)₃C₂H₄N(CH₃)(CH₂)₃Si(OC₄H₉)₃; | H₂NCH₂C₆H₄CH₂CH₂Si(OCH₃)₃; |
| HSCH₂CH₂CH₂Si(OCOCH₃)₃; | HN(CH₃)CH₂CH₂Si(OCH₃)₃; |
| HSCH₂CH₂CH₂SiCH₃(OCH₃)₂; | (H₃CO)₃SiCH₂CH₂CH₂NHCH₂CH₂CH₂Si(OCH₃)₃; |
| HN(CH₃)C₃H₆Si(OCH₃)₃; | CH₃CH₂OOCCH₂CH(COOCH₂CH₃)HNC₃H₆Si(OCH₂CH₃)₃; |
| C₆H₅NHC₃H₆Si(OCH₃)₃; | H₂NC₃H₆SiCH₃(OCH₂CH₃)₂; |
| HOCH(CH₃)CH₂OCONHC₃H₆Si(OCH₂CH₃)₃; | (HOCH₂CH₂)₂NCH₂CH₂CH₂Si(OCH₂CH₃)₃ |
| H₂NCH₂CH₂NHCH₂CH₂CH₂Si(OC₂H₅)3 | H₂NCH₂CH₂NHCH₂CH₂CH₂Si(OCH₃)₃ |

and mixtures thereof.

Isocyanate blocking agents are compounds that upon reaction with an isocyanate group yield a group that is unreactive at room temperature with compounds that at room temperature normally react with an isocyanate but which group at elevated temperature reacts with isocyanate reactive compounds. Generally, at elevated temperature the blocking group will be released from the blocked polyisocyanate group thereby generating the isocyanate group again which can then react with an isocyanate reactive group, such as may be found on the surface of a fibrous substrate. Blocking agents and their mechanisms have been described in detail in “Blocked isocyanates III.: Part. A, Mechanisms and chemistry” by Douglas Wicks and Zeno W. Wicks Jr., Progress in Organic Coatings, 36 (1999), pp. 14-172.

Preferred blocking agents include aryl alcohols such as phenols, lactams such as ε-caprolactam, δ-valerolactam, γ-butyrolactam, oximes such as formaldoxime, acetaldoxime, methyl ethyl ketone oxime, cyclohexanone oxime, acetophenone oxime, benzophenone oxime, 2-butanone oxime or diethyl glyoxime.

Further suitable blocking agents include bisulfite and triazoles. Blocking groups are generally capable of improving durability of the repellency properties or soil/stain release properties include non-fluorinated organic compounds that have one or more groups (or a precursor thereof) capable of reacting with the surface of the fibrous substrate. Examples thereof include compounds that have isocyanate groups or blocked isocyanates as described herein.

The chemical compositions of the present invention may be made according to the following step-wise synthesis. As one skilled in the art would understand, the order of the steps is non-limiting and can be modified so as to produce a desired chemical composition. In the synthesis, the polyfunctional isocyanate compound and the monofunctional fluorochemical compound are dissolved together under dry conditions, preferably in a solvent, and then heating the resulting solution at approximately 40 to 80° C., preferably approximately 60 to 70° C., with mixing in the presence of a catalyst for one-half to two hours, preferably one hour. Depending on reaction conditions (e.g., reaction temperature and/or polyfunctional isocyanate used), a catalyst level of up to about 0.5 percent by weight of the polyfunctional isocyanate/polyoxyalkylene mixture may be used, but typically about 0.00005 to about 0.5 percent by weight is required, with 0.02 to 0.1 percent by weight being preferred.

Suitable catalysts include, but are not limited to, tertiary amine and tin compounds. Examples of useful tin compounds include tin II and tin IV salts such as stannous octanoate, dibutyltin dilaurate, dibutyltin diacetate, dibutyltin di-2-ethylhexanoate, and dibutyltinoxide. Examples of useful tertiary amine compounds include triethylamine, tributylamine, triethylenediamine, tripropylamine, bis(dimethylaminoethyl)ether, morpholine compounds such as ethyl morpholine, and 2,2′-dimorpholinodiethyl ether, 1,4-diazabicyclo[2.2.2]octane (DABCO, Aldrich Chemical Co., Milwaukee, Wis.), and 1,8-diazabicyclo[5.4.0]undec-7-ene (DBU, Aldrich Chemical Co., Milwaukee, Wis.). Tin compounds are preferred.

The resulting fluorochemical functional urethane compounds are then further optionally reacted with one or more of the silane compounds and/or one or more of the isocyanate blocking groups described above. The silane compound or isocyanate blocking group when used is added to the above reaction mixture, and reacts with a substantial portion of the remaining NCO groups. Terminal silane-containing groups are thereby bonded to the isocyanate functional urethane compounds. Aminosilanes are preferred, because of the rapid and complete reaction that occurs between the remaining NCO groups and the silane compound's amino groups. Isocyanato functional silane compounds may be used and are preferred when the ratio of polyfunctional isocyanate compound to the hydrophilic difunctional polyoxyalkylene and fluorochemical monofunctional compound is such that the resulting compound has a terminal hydroxyl group.

These compounds are further reacted with polyoxyalkylene compounds, having an average functionality of 1 or greater, described above by reacting any of the remaining NCO groups in the resulting mixture with one or more of the reactive polyoxyalkylene compounds described above. Thus, the polyoxyalkylene compound(s) is (are) added to the reaction mixture, using the same conditions as with the previous additions. In some instances, the polyoxyalkylene compound(s) may be added at the same time as the fluorochemical compound, and prior to the optional silane or isocyanate blocking group.

Auxiliary Compounds

The coating composition of the invention further comprises an auxiliary compound that is capable of improving the repellency/resistant/release properties. In particular, the auxiliary component improves the oil repellency and stain release in general and the durability of the stain release. The auxiliary compounds are generally non-fluorinated organic compounds and are also called auxiliary compounds hereinafter. Suitable auxiliary compounds capable of improving the oil-repellency properties include for example hydrophobic homopolymers of alkyl esters of acrylic monomers. Auxiliary compounds that are capable of enhancing the soil/stain release properties are generally non-fluorinated organic compounds such as for example hydrophobic homopolymers of alkyl esters of acrylic monomers.

A class of compound that can be advantageously used as the auxiliary component in a fluorochemical urethane treatment composition of this invention include hydrophobic polymers derived from vinyl monomers including polymers of acrylic and/or methacrylic monomers, vinyl acetate and the like. Particular examples of such polymers include homo- and copolymers of alkyl esters of acrylic and methacrylic acid such as, for example, C₁ to C₂₀, preferred C₁ to C₁₁, alkyl esters of acrylic acid. Specific examples of such alkyl esters include methyl(meth)acrylate, ethyl(meth)acrylate, butyl(meth)acrylate, isooctyl(meth)acrylate, dodecyl(meth)acrylate, and octodecyl(meth)acrylate. Specific examples of suitable polymers include a homopolymer of methyl acrylate, a homopolymer of butyl methacrylate, a homopolymer of lauryl methacrylate, a homopolymer of isooctyl acrylate, a homopolymer of methyl methacrylate and a copolymer of methyl acrylate and decyl acrylate.

The weight ratio of the first component fluorochemical urethane compound(s) to the second component auxiliary compound may be from about 99:1 to 40:60 and is typically from about 85:15 to 50:50. It will be understood that it may be possible to use compositions that are outside this range subject to impairment of resultant oil repellency and/or stain resistance.

The treatment composition for fibrous substrates comprises a mixture of the chemical compositions of the present invention and at least one solvent. When applied to fibrous substrates, the treatment compositions impart stain-release characteristics and exhibit durability (i.e., they resist being worn-off) when exposed to wear and abrasion from use, cleaning, and the elements.

Solvent

The chemical compositions of the present invention can be dissolved, dispersed, or emulsified in a variety of solvents to form coating compositions suitable for use in coating the chemical compositions of the present invention onto a substrate. Fibrous substrate treatment compositions may contain from about 0.1 to about 50 weight percent chemical composition. Preferably the chemical composition is used in the coating composition at about 0.1 to about 10 weight percent, most preferably from about 2 to about 4 weight percent.

Suitable solvents include water, alcohols, esters, glycol ethers, amides, ketones, chlorohydrocarbons, chlorocarbons, and mixtures thereof. Depending upon the substrate to which the composition is being applied, water is the preferred solvent because it does not raise any environmental concerns and is accepted as safe and non-toxic.

Substrate

The treatment compositions of the present invention can be applied to a wide variety of fibrous substrates resulting in an article that displays durable stain-release properties. The article of the present invention comprises a fibrous substrate having a treatment derived from at least one solvent and a chemical composition of the present invention. After application and curing of the coating composition, the substrate displays durable stain-release properties.

The treatment composition may also be applied to other substrates including glass, ceramic, stone, metal, semi-porous materials such as grout, cement and concrete, wood, paint, plastics, rubber.

The treatment compositions of the present invention can be applied to a wide variety of fibrous substrates including woven, knit, and nonwoven fabrics, textiles, carpets, leather, and paper. Substrates having nucleophilic groups, such as cotton are preferred because they can bond to the silane groups and/or blocked isocyanate groups when present in the chemical compositions of the present invention, thereby increasing durability of the fiber treatment. Any application method known to one skilled in the art can be used including spraying, dipping, immersion, foaming, atomizing, aerosolizing, misting, flood-coating, and the like.

To impart release/repellency/resistance characteristics to a fibrous substrate, the coating composition of the present invention is applied to the substrate and is allowed to cure (i.e., dry), at ambient or elevated temperature.

In order to treat a fibrous substrate the fibrous substrate is contacted with the fluorochemical coating composition of the invention. For example, the substrate can be immersed in the fluorochemical treating composition. The treated substrate can then be run through a padder/roller to remove excess fluorochemical composition and dried or cured. The treated substrate may be dried at room temperature by leaving it in air or may alternatively or additionally be subjected to a heat treatment, for example, in an oven. A heat treatment is typically carried out at temperatures between about 50° C. and about 190° C. depending on the particular system or application method used. In general, a temperature of about 120° C. to 170° C., in particular of about 150° C. to about 170° C. for a period of about 20 seconds to 10 minutes, preferably 3 to 5 minutes, is suitable. Alternatively, the chemical composition can be applied by spraying the composition on the fibrous substrate. An ambient cure preferably takes place at approximately 15 to 35° C. (i.e., ambient temperature) until dryness is achieved, up to approximately 24 hours. With either heat-treatment or ambient cure, the chemical composition can also form chemical bonds with the substrate and between molecules of the chemical composition.

The choice of either heat-treatment or ambient cure often depends on the desired end-use. For consumer applications, where the composition may be applied to household laundry or carpeting, an ambient cure is typically desired. For industrial applications, where the fibrous substrate, such as a textile might normally be exposed to elevated temperatures during production, an elevated temperature cure or heat-treatment may be desirable. The amount of the treating composition applied to the fibrous substrate is chosen so that a sufficiently high level of the desired properties are imparted to the substrate surface without substantially affecting the look and feel of the treated substrate. Such amount is usually such that the resulting amount of the fluorochemical urethane composition on the treated fibrous substrate will be between 0.05% and 5% by weight based on the weight of the fibrous substrate, known as solids on fabric or SOF. The amount that is sufficient to impart desired properties can be determined empirically and can be increased as necessary or desired.

Fibrous substrates that can be treated with the fluorochemical composition include in particular, textiles. The fibrous substrate may be based on synthetic fibers, e.g., polyester, polyamide and polyacrylate fibers or natural fibers, e.g., cellulose fibers as well as mixtures thereof. The fibrous substrate may be a woven as well as a non-woven substrate. Preferred substrates are cellulosic materials such as cotton, rayon, TENCEL™ and blends of cellulosic materials.

The resulting treated substrates derived from at least one solvent and a chemical composition of the present invention, have been found to be resist soils and/or stains and/or to release soils and/or stains with simple washing methods. The cured treatments have also been found to be durable and hence to resist being worn-off due to wear and abrasion from use, cleaning, and the elements.

The invention will now be further illustrated with reference to the following examples without the intention to limit the invention thereto. All parts and percentages are by weight unless stated otherwise.

### EXAMPLES

The following materials were used in the examples.

TABLE 1

| Designation | Material | Source/Preparation |
|---|---|---|
| APTES | 3-aminopropyltriethoxysilane; NH₂(CH₂)₃Si(OC₂H₅)₃ | Sigma-Aldrich, Milwaukee, WI |
| APTMS | 3-aminopropyltrimethoxysilane; NH₂(CH₂)₃Si(OCH₃)₃ | Sigma-Aldrich |
| Butyl methacrylate | CH₂═C(CH₃)COO(CH₂)₃CH₃ | Sigma-Aldrich |
| DBTDL | Dibutyltin dilaurate; [CH₃(CH₂)₃]₂Sn[OOC(CH₂)₁₀CH₃]₂ | Sigma-Aldrich |
| DTAB | Dodecyl trimethyl ammonium bromide; CH₃(CH₂)₁₁N(CH₃)₃Br | Sigma-Aldrich |
| Ethoquad ™ 18/25 | Octadecylmethyl[polyoxyethylene (15)] ammonium | Akzo Nobel, Chicago, IL |
| | chloride; RN(+)(CH₃)[(CH₂CH₂O)ₘH][(CH₂CH₂O)ₙH] Cl(−) | |
| Ethyl acetate | CH₃CO₂C₂H₅ | Sigma-Aldrich |
| Isooctyl acrylate | H₂C═CHCO₂(CH₂)₅CH(CH₃)₂ | Sigma-Aldrich |
| Lauryl methacrylate | CH₂═C(CH₃)COO(CH₂)₁₁CH₃ | Sigma-Aldrich |
| MeFBSE | N-methylperfluorobutanesulfonyl ethanol; | Made by reacting perfluorobutane- |
| | C₄F₉SO₂N(CH₃)CH₂CH₂OH | sulfonyl fluoride with CH₃NH₂ |
| | | and ethylene chlorohydrin, |
| | | essentially as described in Example |
| | | 1 of U.S. Pat. No. 2,803,656 |
| | | (Ahlbrecht, et al.) |
| Methyl acrylate | CH₃O₂CC(H)═CH₂ | Sigma-Aldrich |
| MIBK | Methylisobutyl ketone; (CH₃)₂CHCH₂C(O)CH₃ | Sigma-Aldrich |
| MPEG 750 | CARBOWAX ™ 750; Methoxypolyethylene glycol (MWₐᵥ = 750) | Union Carbide, Danbury, CT |
| N3300 | DESMODUR ™ N-3300; eq wt = 194 Polyfunctional | Bayer, Pittsburgh, PA |
| | isocyanate resin based on hexamethylene diisocyanate | |
| PEG 1450 | CARBOWAX ™ 1450; Polyethylene glycol (MWₐᵥ = 1450) | Union Carbide |
| TDDM | Tert-Dodecyl mercaptan; C₁₂H₂₅SH | Sigma-Aldrich |
| V-50 | 2,2′-Azobis(2-methylpropionamide)dihydrochloride | Wako Chemicals USA, Richmond, VA |
| Vazo ® 67 | substituted azonitrile free radical initiator | DuPont |

Fabric

The fabric tested was 100% cotton woven twill fabric (Style: Super Hippogator™; Color: Khaki) from Avondale Mills, Graniteville, S.C.

Application and Testing of Compositions

A 100% cotton twill fabric was sent through a horizontal padder that contained a bath of the diluted polymer, and was then immediately sent through a set of nip rollers. The concentration of the bath was adjusted to produce a fabric that when dry had a fluorochemical coating of 0.3, 0.6 and 1.0 percent solids based on the fabric total weight (% SOF).

The bath also contained a glyoxal-type resin, Freerez® PFK (from Noveon, Charlotte, N.C.) at about 12 percent based on the weight of the bath, a catalyst, Freecat® MX (from Noveon, Charlotte, N.C.) at about 3 percent based on the weight of the bath, and a sewing lubricant, Patsoft™ PHD (from Chemical Technologies, Charlotte, N.C.), at about 2 percent based on the weight of the bath. The fabric was then dried and cured in an oven for 10 minutes at 310° F. (150° C.). Various performance tests were run on the fabric.

Performance Test—Oil Repellency

This test measures the resistance of the treated fabric to oil-based insults. A drop of one standard surface tension fluid (of a series of 8, with decreasing surface tensions) is dropped on a treated fabric. If after thirty seconds there is no wetting, the next highest standard number fluid (next lowest surface tension) is tested. When the lowest number fluid soaks into the fabric, the next lower number is the rating. For example, the fabric will receive a three rating, if the number four fluid wets the fabric. A more detailed description of the test is written in the 3M Protective Material and Consumer Specialties Division's “Oil Repellency Test I” method (Document # 98-0212-0719-0).

Performance Test—Stain Release

This test evaluates the release of forced-in oil-based stains from the treated fabric surface during simulated home laundering. As indicated below, three stains were applied—Stain K (mineral oil), Stain E (corn oil), Stain C (dirty motor oil). These stains (five drops of each stain) were applied to the same area of the fabric with a dropper from a short distance above, covered with glassine paper and weighted with ¼ lb weights for one minute. The weights and glassine paper were removed from the fabric. The fabric was then blotted and allowed to hang for one hour before laundering.

In the laundering process, a maximum of forty stains were allowed in one load. A 14 minute wash cycle was used with 100 grams of powdered Tide® (Procter and Gamble). The laundered stains were then tumble dried for 30 minutes. Stains were evaluated on a 1 to 8 scale. A rating of 8 represents total removal of the stain, and a rating of 1 represents a very dark stain. The rating scale used was the same as described in the 3M Protective Material and Consumer Specialties Division's Stain Release Document # 98-0212-0740-6.

Stain Release—Durability

The Stain Release Test was run on treated fabric after initial treatment and after 5 consecutive launderings followed by 45 minute tumble-drying. Details to the laundering procedure are found in the 3M Protective Materials “Laboratory Laundering Procedures” for home laundering simulation (Document #98-0212-0703-4).

Preparation of Fluorochemical Urethane Dispersion A

Fluorochemical urethane MeFBSE/N3300/PEG 1450/APTES

A 1 liter flask was charged with MeFBSE (58.89 grams), DBTDL (3 drops; ˜20 milligrams) and MIBK (237.0 grams). The temperature of the stirred mixture was raised to 140° F. (60° C.) under a purge of dry nitrogen. N-3300 polyisocyanate (40.0 grams) was then slowly added, maintaining the temperature between 140 to 149° F. (60 to 65° C.). Upon completion of the addition, the reaction mixture was stirred for 1 hour at 140° F. (60° C.). APTES (4.56 grams) was then added dropwise, keeping temperature of the reaction mixture below 149° F. (65° C.), and the reaction mixture was stirred for 30 minutes. Solid PEG 1450 (14.95 grams) was added to the stirred mixture, and the reaction was followed to completion via FTIR, as determined by disappearance of the —NCO band at approximately 2289 wavenumbers.

Emulsification: DI water (944 grams; at 140° F. (60° C.)) was slowly added to this vigorously stirred organic mixture. This pre-emulsion mixture was then sonicated for 2 minutes. A rotary evaporator connected to an aspirator was used to strip the MIBK from the mixture. The resulting emulsion was 20 to 30 percent solids.

Preparation of Fluorochemical Urethane Dispersion B

Fluorochemical urethane MeFBSE/N3300/MPEG 750

To a one liter three-necked round bottom flask fitted with a water cooled distilling head, overhead mechanical stirrer, thermocouple, temperature controller, nitrogen inlet and heating mantle was charged MeFBSE (50.08 grams), MPEG 750 (18.57 grams) and ethyl acetate (150 grams). The solution was heated to reflux to remove residual water by azeotropic distillation of ethyl acetate. 50 mL of ethyl acetate were removed. (A sample of the reaction mixture was then analyzed for residual water to ascertain it was less than 0.05 percent using the Karl Fischer technique.) When the water was within specification, 31.35 grams N-3300 polyisocyanate was added, using a small amount of additional ethyl acetate to rinse all of the isocyanate into the reaction vessel. The reaction mixture was heated to 167° F. (75° C.) under a nitrogen atmosphere and 0.3 mL of a solution of 10 weight percent DBTDL catalyst in ethyl acetate was added in one portion. After an exothermic reaction subsided, the reaction was held at 167° F. (75° C.) overnight. The reaction was complete when the isocyanate had been consumed and the —NCO peak at 2270 cm⁻¹ was no longer visible in the FTIR. The approximately 50 weight percent solids solution of the fluorochemical urethane in ethyl acetate was then cooled to room temperature.

A premixed solution of 2.0 grams Ethoquad™ 18/25 and 300 grams DI water was prepared in a 500 ml flask. This solution was added in one portion to the ethyl acetate solution of the urethane at room temperature with sufficient agitation to thoroughly mix both phases. The combined material was homogenized using a Cole-Parmer Instruments ultrasonic processor model CPX600 for five minutes at 100% power. The ethyl acetate was removed using a rotary evaporator at reduced pressure with a bath temperature at 120° F. (50° C.). The solids were 30 weight percent.

Preparation of Fluorochemical Urethane Dispersion C

Fluorochemical urethane MeFBSE/N3300/PEG 1450/APTMS

To a ninety gallon stainless steel reactor was charged 95 pounds MeFBSE and 112 pounds ethyl acetate. The solution was heated to reflux to remove residual water by azeotropic distillation of ethyl acetate. 22 pounds of ethyl acetate were removed. (A sample of the reaction mixture was them analyzed for residual water to ascertain it was less than 0.05 percent using the Karl Fischer technique.) When the water was within specification, 61 pounds Desmodur™ N-3300 polyisocyanate was added. The reaction mixture was heated to 105° F. under a nitrogen atmosphere and a solution of 12 grams DBTDL catalyst and 5 mL of ethyl acetate was added in one portion. After an exothermic reaction subsided, the reaction was held at 165° F. (74° C.) for two hours. The batch was cooled to 100° F. and 22.4 pounds PEG 1450 was added to the reaction mixture. A premixed solution of 25 grams APTMS and 5 grams ethyl acetate was then added. The temperature was raised to 165° F. (74° C.) and held there for two hours. Water (65 grams) was then added to the reactor. The temperature was reduced to 140° F. (60° C.) and held there for thirty minutes. The solution of the fluorochemical urethane in ethyl acetate was then cooled to room temperature. This urethane was emulsified in the same manner as described for Fluorochemical Urethane Dispersion A.

Preparation of Poly(Methyl Acrylate) Dispersion

The poly(methyl acrylate) homopolymer dispersion was prepared by making a premixed solution of methyl acrylate monomer (80 grams) and TDDM (0.4 grams). The premix was purged with nitrogen by three vacuum-nitrogen cycles and kept under nitrogen.

A one liter three-necked round bottom flask was charged with) DI water (231.3 grams, Ethoquad™ 18/25 surfactant (3 grams), methyl acrylate (20 grams) and TDDM (0.1 grams). The aqueous mixture was purged with nitrogen by three vacuum-nitrogen cycles. The reactor was kept under a nitrogen cap. The temperature of the reactor was raised to 140° F. (60° C.). While the reactor was being heated to 140° F. (60° C.) a premix of 0.1 grams V-50 initiator in 2 grams DI water was prepared. When the temperature of the flask reached 140° F. (60° C.) the premix of V-50 and water was added in one portion. After a mild exotherm, the batch was held at 140° F. (60° C.) for one hour. The remaining premix of methyl acrylate/mercaptan was then continuously added to the reactor over a period of two hours. After addition of the monomer/mercaptan premix was completed the reaction was stirred for an additional three hours at 140° F. (60° C.). The final dispersion was 30% solids.

Emulsification of Poly(Vinyl Acetate)

26.4 grams poly(vinyl acetate) (Mw=83,000; from Aldrich) was dissolved in 75 grams ethyl acetate. Ethoquad™ 18/25 (2.6 grams of a 30 percent by weight solution in water) was added to about 95 grams DI water. This surfactant solution was then added continuously to the ethyl acetate solution of the polymer, heated to 120° F. (50° C.), over about 20 minutes. The resulting mixture was then sonicated for 10 minutes and the ethyl acetate solvent subsequently removed by rotary evaporation. Some of the polymer precipitated during the solvent removal step. The resulting mixture was 14.7 percent by weight solids.

Preparation of Poly(Lauryl Methacrylate) Dispersion

Into a one liter, three-necked round bottom flask equipped with an overhead stirrer, water cooled condenser and thermocouple temperature probe were added a mixture of 75.0 grams lauryl methacrylate, Ethoquad™ 18/25 (5.0 grams of a 30 percent by weight solution in water), 0.22 grams TDDM and 300 grams DI water which had been sonicated to give what appeared to be a white, stable suspension. The reaction flask was evacuated and filled with nitrogen over four cycles using a Firestone valve and heated to 55° C. To this reaction mixture was added 0.08 g Vazo™ 67 and 0.08 g V-50 initiators. No exotherm was noted. The reaction temperature was raised to 140° F. (60° C.) for 16 hours. After completion of the reaction, the white mixture was decanted from a small amount of coagulated polymer and found to be 17.1 percent by weight solids.

Preparation of Poly(Butyl Methacrylate) Dispersion

The poly(butyl methacrylate) homopolymer dispersion was prepared in a 500 mL, 3-necked round bottom flask fitted with a water cooled condenser, overhead mechanical stirrer, thermocouple, temperature controller, nitrogen inlet and heating mantle. 50 grams of butyl methacrylate monomer (from Aldrich) was placed in the flask with 200 grams DI water and 3.33 grams Ethoquad™ 18/25 (30 percent by weight solution in water). The mixture was purged with nitrogen by three vacuum-nitrogen cycles and kept under nitrogen.

The flask was then charged with 0.25 grams V-50 and 0.25 grams tert-dodecyl mercaptan. The temperature of the reaction mixture was raised to 140° F. (60° C.) in 41° F. (5° C.) increments, letting the exotherm subside at each increment before proceeding. Once the reaction reached 140° F. (60° C.), the reaction was allowed to continue overnight. The next day, there was some coagulum around the stir shaft. The fluid portion of the reaction mixture was a blue translucent emulsion. The emulsion was decanted from the flask. The percent solids were 12.3 weight percent in water.

Preparation of Poly(Isooctyl Acrylate) Dispersion

The poly(isooctyl acrylate) homopolymer dispersion was prepared in a 250 mL, 3-necked round bottom flask fitted with a water cooled condenser, overhead mechanical stirrer, thermocouple, temperature controller, nitrogen inlet, and heating mantle. 2 grams of isooctyl acrylate monomer were placed in the flask with 150 grams DI water and 1 gram DTAB. The mixture was purged with nitrogen and kept under nitrogen. After the temperature of the reactor was raised to 100° F. (40° C.), the flask was then charged with a premix of 0.04 grams V-50 and 10 grams DI water. After a mild exotherm, the batch was held at 100° F. (40° C.) for one hour. 38 grams of isooctyl acrylate were then continuously added into the reactor over a period of two hours. The reaction was allowed to continue overnight at 100° F. (40° C.), and then heated to 140° F. (60° C.) for another two hours the next day. The emulsion was decanted from the flask. The final percent solids were 20 weight percent in water.

Preparation of Blends

Blends of the fluorochemical urethanes (such as Fluorochemical Urethane Dispersion A, Fluorochemical Urethane Dispersion B, or Fluorochemical Urethane Dispersion C) and hydrophobic auxiliary compounds (such as poly(methyl acrylate)) were prepared by weighing the desired ratio of the compounds into a container and mixing well.

### Examples 1-6

Examples 1-6 were blends of Fluorochemical Urethane Dispersion A, Fluorochemical Urethane Dispersion B, or Fluorochemical Urethane Dispersion C with poly(methyl acrylate). The weight ratios of the blends are given in Table 2.

TABLE 2

| | Fluorochemical | Fluorochemical |
|---|---|---|
| Example | Urethane | Urethane:Poly(Methyl Acrylate) |
| 1 | A (“FC A”) | 75:25 |
| 2 | A | 66:34 |
| 3 | B (“FC B”) | 85:15 |
| 4 | B | 78:22 |
| 5 | C (“FC C”) | 85:15 |
| 6 | C | 78:22 |

The blends of Examples 1-6 were applied to a 100% cotton woven twill fabric as described above and were tested for oil repellency and stain release using the test methods described above. Results are given in Tables 3, 4 and 5.

TABLE 3
Results*

| | |
|---|---|
| Initial | 5L |

| | % SOF | Oil Repellency | Stain K | Stain K |
|---|---|---|---|---|
| FC A | 0.3 | 1.8 | 6.3 | 4.5 |
| | 0.6 | 3.2 | 6.7 | 5.5 |
| | 1.0 | 5.0 | 7.3 | 6.8 |
| 1 | 0.3 | 1.3 | 6.1 | 4.2 |
| | 0.6 | 2.7 | 6.5 | 5.2 |
| | 1.0 | 4.6 | 7.0 | 6.5 |
| 2 | 0.3 | 1.1 | 6.0 | 4.1 |
| | 0.6 | 2.5 | 6.4 | 5.1 |
| | 1.0 | 4.4 | 6.9 | 6.5 |
| FC B | 0.3 | 2.5 | 6.2 | 3.2 |
| | 0.6 | 3.7 | 6.9 | 3.8 |
| | 1.0 | 5.4 | 7.8 | 4.6 |
| 3 | 0.3 | 2.3 | 6.1 | 3.5 |
| | 0.6 | 3.6 | 6.7 | 4.1 |
| | 1.0 | 5.3 | 7.6 | 4.9 |
| 4 | 0.3 | 2.3 | 6.0 | 3.7 |
| | 0.6 | 3.5 | 6.7 | 4.3 |
| | 1.0 | 5.2 | 7.5 | 5.1 |
| FC C | 0.3 | 2.2 | 5.9 | 3.5 |
| | 0.6 | 3.9 | 6.5 | 4.6 |
| | 1.0 | 6.0 | 7.4 | 6.1 |
| 5 | 0.3 | 2.0 | 5.9 | 3.7 |
| | 0.6 | 3.6 | 6.5 | 4.9 |
| | 1.0 | 5.8 | 7.4 | 6.4 |
| 6 | 0.3 | 1.9 | 5.9 | 3.8 |
| | 0.6 | 3.5 | 6.5 | 4.9 |
| | 1.0 | 5.7 | 7.4 | 6.5 |

*of at least five samples in each instance.

Convert % SOF into ppmF applied to substrate by using the weight percent fluorine in Fluorochemical Urethane A and the fraction of Fluorochemical Urethane A in the blend.

TABLE 4
Initial Oil Repellency

Example

| | 750 | 1000 | 1500 | 2000 |
|---|---|---|---|---|
| | ppmF | ppmF | ppmF | ppmF |
| Fluorochemical | 1.8 | 2.3 | 3.2 | 4.2 |
| Urethane A Control | | | | |
| 1 | 1.8 | 2.4 | 3.7 | 4.9 |
| 2 | 1.8 | 2.5 | 3.9 | 5.3 |
| Fluorochemical | 2.6 | 3.0 | 3.9 | 4.8 |
| Urethane B Control | | | | |
| 3 | 2.6 | 3.2 | 4.2 | 5.3 |
| 4 | 2.6 | 3.2 | 4.4 | 5.5 |
| Fluorochemical | 2.2 | 2.7 | 3.8 | 4.8 |
| Urethane C Control | | | | |
| 5 | 2.5 | 3.2 | 4.6 | 6.0 |
| 6 | 2.7 | 3.5 | 5.1 | 6.7 |

TABLE 5
Stain K Release (after five launderings)

Example

| | 750 | 1000 | 1500 | 2000 |
|---|---|---|---|---|
| | ppmF | ppmF | ppmF | ppmF |
| Fluorochemical | 4.4 | 4.8 | 5.4 | 6.1 |
| Urethane A Control | | | | |
| 1 | 4.6 | 5.0 | 5.9 | 6.8 |
| 2 | 4.6 | 5.1 | 6.1 | 7.1 |
| Fluorochemical | 3.3 | 3.5 | 3.9 | 4.3 |
| Urethane B Control | | | | |
| 3 | 3.7 | 4.0 | 4.5 | 5.0 |
| 4 | 3.9 | 4.2 | 4.7 | 5.3 |
| Fluorochemical | 3.4 | 3.8 | 4.6 | 5.3 |
| Urethane C Control | | | | |
| 5 | 4.1 | 4.6 | 5.6 | 6.6 |
| 6 | 4.4 | 5.0 | 6.1 | 7.3 |

Converting these % SOFs to ppmF and doing the data analysis yields plots from which the performance at any ppmF level can be determined. These are the numbers used in the tables when ppmF is the treatment level.

The effects of the invention are much more clearly seen when ppmF is used as the comparison, i.e., it is surprising that at the same fluorine add-on level the addition of a hydrophobic polymer increases oil repellency and stain release characteristics.

### Examples 7-13

Blends of Fluorochemical Urethane A with other acrylic polymers were prepared as described above. The blend compositions and weight ratios are summarized in Table 6.

TABLE 6

| | | Fluorochemical |
|---|---|---|
| Example | Acrylic PolymerType | Urethane:Acrylic Polymer |
| 7 | Poly(lauryl methacrylate) | 80:20 |
| 8 | Poly(vinyl acetate) | 80:20 |
| 9 | Poly(butyl methacrylate) | 80:20 |
| 10 | Poly(isooctyl acrylate) | 90:10 |
| 11 | Poly(isooctyl acrylate) | 80:20 |
| 12 | Poly(isooctyl acrylate) | 70:30 |
| 13 | Poly(isooctyl acrylate) | 60:40 |

The blends of Examples 7-13 were applied to a 100% cotton woven twill fabric as described above and were tested for initial oil repellency and stain release using the test methods described above. Results are given in Tables 7.

TABLE 7

| | Example | | | | |
|---|---|---|---|---|---|
| | % | Oil | Stain K | Stain E | Stain C |
| | SOF | Repellency | Release | Release | Release |
| Fluorochemical | 0.6 | 4.1 | 6.6 | 7.3 | 4.2 |
| Urethane A Control* | | | | | |
| 7* | 0.6 | 2.5 | 6.2 | 7.0 | 4.1 |
| 8* | 0.6 | 3.8 | 6.2 | 7.3 | 4.5 |
| 9* | 0.6 | 3.8 | 5.9 | 7.0 | 4.2 |
| Fluorochemical | 1.0 | 4.9 | 7.4 | 7.5 | 4.8 |
| Urethane A Control* | | | | | |
| 7* | 1.0 | 4.2 | 6.8 | 7.5 | 4.1 |
| 8* | 1.0 | 5.0 | 7.5 | 7.5 | 4.8 |
| 9* | 1.0 | 5.0 | 7.3 | 7.3 | 4.1 |
| Fluorochemical | 0.3 | 2.1 | 7.0 | 7.4 | 4.2 |
| Urethane A Control** | | | | | |
| 10** | 0.3 | 2.0 | 7.0 | 7.0 | 4.0 |
| 11** | 0.3 | 1.5 | 7.0 | 6.5 | 4.0 |
| 12** | 0.3 | 1.0 | 6.5 | 6.5 | 3.5 |
| 13** | 0.3 | 1.0 | 7.0 | 6.5 | 3.5 |

*Results from at least five samples
**Results from a single sample.

What is claimed is:

1. A chemical composition comprising:
(a) a first component comprising one or more fluorochemical urethane compounds comprising the reaction product of:
(1) one or more polyfunctional isocyanate compounds;
(2) one or more hydrophilic polyoxyalkylene compounds; and
(3) one or more fluorochemical monofunctional compounds; and
(b) a second component comprising one or more hydrophobic auxiliary compounds capable of further improving the oil-repellency or soil/stain release properties of a fibrous substrate treated with the fluorochemical urethane compounds;
wherein said auxiliary compounds of said second component are selected from the group consisting of hydrophobic addition polymers of vinyl monomers.

2. The chemical composition of claim 1 wherein the polyfunctional isocyanate compound of said first component is a diisocyanate or triisocyanate.

3. The chemical composition of claim 1 wherein the fluorochemical monofunctional compound of said first component is of the formula:
R_{f}-Z-R²—X
wherein R_{f} is a perfluoroalkyl group or a perfluoroheteroalkyl group, e.g., C₄F₉—; Z is a connecting group selected from a covalent bond, a sulfonamido group, a carboxamido group, a carboxyl group, or a sulfonyl group; R² is a divalent straight or branched chain alkylene, cycloalkylene, or heteroalkylene group of 1 to 14 carbon atoms; and X is —NH₂; —SH; —OH; —COOH; or —NRH where R is selected from the group consisting of phenyl, straight and branched aliphatic, alicyclic, and aliphatic ester groups.

4. The chemical composition of claim 3 wherein R_{f} is a perfluoroalkyl or a perfluoroheteroalkyl group of 2 to 12 carbons.

5. The chemical composition of claim 3 wherein R_{f} is a perfluoroalkyl group or a perfluoroheteroalkyl of 3 to 5 carbons.

6. The composition of claim 1 wherein said first component polyoxyalkylene compounds are homopolymers of polyoxyethylene and copolymers of polyoxyethylene and polyoxypropylene.

7. The composition of claim 1 wherein said first fluorochemical urethane compound is the reaction product of:
(1) one or more polyfunctional isocyanate compounds;
(2) one or more hydrophilic polyoxyalkylene compounds;
(3) one or more fluorochemical monofunctional compound; and
(4) one or more silane compounds of the formula:
X—R¹—Si—(Y)₃
wherein X is —NH₂; —SH; —OH; —N═C═O; or —NRH where R is selected from the group consisting of phenyl, straight and branched aliphatic, alicyclic, and aliphatic ester groups; R¹ is an alkylene, heteroalkylene, aralkylene, or heteroeryl aliphatic group; and each Y is independently a hydroxyl; a hydrolyzable moiety selected from the group consisting of alkoxy, acyloxy, heteroalkoxy, heteroacyloxy, halo, and oxime; or a non-hydrolyzable moiety selected from the group consisting of phenyl, alicyclic, straight-chain aliphatic, and branched-chain aliphatic, wherein at least one Y is a hydrolyzable moiety.

8. The composition of claim 1 wherein said first fluorochemical urethane compound is the reaction product of:
(1) one or more polyfunctional isocyanate compounds;
(2) one or more hydrophilic polyoxyalkylene compounds;
(3) one or more fluorochemical monofunctional compound; and
(4) an isocyanate blocking group.

9. The composition of claim 1 wherein said polyoxyalkylene compounds of said second component are homopolymers of polyoxyethylene and copolymers of polyoxyethylene and polyoxypropylene or polyoxytetramethylene.

10. The composition of claim 1 wherein the amount of said hydrophilic polyoxyalkylene compounds of said first component is sufficient to react with between about 0.1 and 30 percent of isocyanate groups, the amount of said optional silane compounds is sufficient to react with between about 0.1 and 25 percent of isocyanate groups, the amount of said optional blocked isocyanate group compounds is sufficient to react with between about 0.1 and 60 percent of isocyanate and the amount of said fluorochemical monofunctional compounds is sufficient to react with between 40 and 90 percent of isocyanate groups, wherein said isocyanate group are of said first component polyfunctional isocyanate compounds.

11. The composition of claim 1 wherein said polyoxyalkylene compound of said first component has a functionality of 1 or greater.

12. The composition of claim 1 wherein said second component is selected from the group consisting of homo- and copolymers of methyl(meth)acrylate, ethyl (meth)acrylate, butyl(meth)acrylate, isooctyl(meth)acrylate, dodecyl(meth)acrylate, and octadecyl(meth)acrylate.

13. A treatment composition comprising a solution of the chemical composition of claim 1 and a solvent.

14. The treatment composition of claim 13 wherein the solvent is selected from the group consisting of water, an organic solvent, and mixtures thereof.

15. The treatment composition of claim 13 comprising from about 0.1 to about 50 weight percent of said chemical composition.

16. An article comprising a substrate having a cured coating derived from at least one solvent and a chemical composition of claim 1.

17. The article of claim 16 wherein said substrate is a fibrous substrate.

18. A method for imparting stain-release characteristics to a substrate comprising the steps of applying the treatment composition of claim 1, and allowing the coating composition to cure.

19. The method of claim 18 wherein said substrate is a fibrous substrate

20. The method of claim 19 wherein said coating composition is applied in an amount sufficient to provide between about 0.05 and 5 percent by weight solids on fiber.

21. A method for imparting stain-release characteristics to a fibrous substrate comprising the steps of:
(a) applying a treatment composition of claim 8, and
(b) curing the coating composition at elevated temperature to deblock said blocked isocyanate groups.
